(19) United States
(12) Patent Application Publication
(10) Pub. No.: US 2009/0107570 A1
(43) Pub. Date: Apr. 30, 2009

(54) Hydraulic Accumulator

(76) Inventor: Norbert Weber, Sulzbach/Saar (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/084,892

(22) PCT Filed: Sep. 26, 2006
(86) PCT No.: PCT/EP2006/009332

§ 371 Date: May 13, 2008

(30) Foreign Application Priority Data
Jan. 25, 2006 (DE) 102006004120.8

(51) Int. Cl. F15B 1/04; B65D 1/32

(52) U.S. Cl. 138/30; 220/721; 138/26

(57) ABSTRACT

The invention relates to a hydraulic accumulator, in particular a bladder accumulator, comprising two at least partially adjacent plastic casings (12, 14). The first plastic casing (12) comprises a collar part (16) at least at one end thereof. The aim of the invention is to produce a leakproof accumulator arrangement which is economical to produce. To achieve this, a gap opening (24) between the casings (12, 14) extends up to a point, at which the casings (12, 14) are positioned together in a coaxial manner, and a disk valve (50) is provided as a valve for controlling the supply and discharge of the medium in the opening (10).

The invention relates to a hydraulic accumulator, in particular a bladder accumulator, for holding at least one fluid medium, with a pressurized container, with a first plastic casing and a second plastic casing which at least partially encompasses the first plastic casing, the first plastic casing at least on its one end having a collar part which comprises an opening for the delivery and discharge of the medium, and the collar part and the second plastic casing being supported on an interposed outside support ring which tapers in the manner of a wedge in the direction of the gap opening between the indicated casings.

EP 1 248 929 B1 discloses a plastic core container reinforced with a fiber plastic composite as the inner plastic casing for storing liquid and/or gaseous media under pressure, the core container having one of more fittings in the neck part and/or the bottom part and/or the cylindrical container part, of which at least one fitting is made to hold a screw-on pressure line feed which has a cylindrical or conical thread, such as for example a valve or a pipeline connection.

In the connection shank of the plastic core container, a cylindrical insert with a collar end which runs peripherally or envelops on the end of the connecting shank is mounted as the collar part, at least two seals being arranged such that at least one seal is located between the insert and the inside surface of the plastic connection shank of the plastic core container and at least one other seal is located between the insert and pressure line feed. This is to ensure a high level of long-lasting tightness on the fitting even under extreme, cyclic thermal and mechanical operating stresses. Due to the sharp deflection site of the first inner plastic casing in the direction of the collar part by approximately 90°, it cannot be precluded that as a result of the sharp deflection site harmful stress peaks will occur, and although the outside support ring between the outer and inner plastic casing within the gap opening formed thereby tapers conically or in the manner of a wedge to the outside, the resulting support takes place only within the essentially horizontally running contact region of the two indicated plastic casings, with the result that relative movements which can damage the plastic can occur between the casings in the indicated region during operation of the device.

DE 197 51 411 C1 discloses a composite pressurized container for storage of gaseous media under pressure with a plastic liner as the inner or first plastic casing, with two neck pieces located in the neck region and with a winding of a fiber composite material which reinforces the liner as the second plastic casing. In the neck piece which holds the gas check valve, there is a clamp ring which can be screwed into this neck piece and which on the outer casing has a threaded section which is adjoined by an unthreaded, truncated cone-like section and the annular groove which is located between the internal threaded sections of the neck piece for holding a gasket extends radially into the neck piece and on the outside of the respective neck piece. In the region adjoining the collar, the arrangement is provided with at least one bead which extends radially to the outside over the entire periphery. Likewise, as in the above aforementioned solution, the wedge-like taper of the outside support ring extends only along the inner peripheral region on the neck piece along a horizontal plane which is formed by the liner and which in this respect, deflected in turn at a sharp right angle, ends in the collar part which encompasses the gas supply via the indicated valve. The in turn very effectively sealing solution for its implementation uses correspondingly great technical effort with several components.

On the basis of this prior art, the object of the invention is to further improve the known solutions such that the hydraulic accumulator can be used in an economical manner at a reduced production cost and that the hydraulic accumulator is characterized by high reliability. This object is achieved by a hydraulic accumulator with the features of claim 1 in its entirety.

In that, as specified in the characterizing part of claim 1, the gap opening between the casings is routed as far as the site at which the casings are in contact with one another in a coaxial arrangement, and in that for triggering the delivery and discharge of media in the opening a disk valve is used as the valve, a tight accumulator arrangement is created which can be implemented at low production costs. The hydraulic accumulator according to the invention can be used for a plurality of applications and in that support takes place as far as into the outer peripheral region of the two casings by way of an outside support ring which tapers in the manner of a wedge, relative movements which may occur between the plastic casings are accommodated by way of the outside support ring, and damaging delamination processes directly between the susceptible plastic materials are avoided. Furthermore, in this way stable and reliable support for the disk valve in the opening region of the pressurized container is created so that it is possible for the first time with the indicated features to use accumulators which are made entirely of plastic layers for bladder-hydraulic accumulator solutions which are also built with an extremely large volume. Furthermore, standard plastic materials, for example, in the form of polymer materials, can be used due to the wedge-like intermediate support for the plastic casings; this in turn helps cut production costs.

The contour surfaces of the first and second plastic casing which face one another can be implemented based on the wedge-like routing of the outside support ring which leads into the outer peripheral region of the arrangement without sharp deflections and without sudden changes of direction; this enables especially careful application of force for the indicated plastic casings. The application of force is especially favorable when the outside support ring is made in one piece and then preferably consists of a plastically deformable plastic material, especially of a polymer material. Good results can, however, also be achieved when the outside support ring as a rigid support part body is composed of at least two individual segments, for example, in the manner of individual rings; this in turn simplifies production and accordingly helps reduce production costs. The outside support ring, to the extent it supports the collar part of the liner, can here be made of a metal material and the wedge-like tapering region between the plastic casings consists of a plastic material, for example, in the form of a plastically deformable buffer ring of polymer material. Depending on the production process, this plastically deformable plastic can also be injected or cast into the defined gap. If the buffer ring or the outside support ring as a whole consists of a plastic material, this leads to a significant reduction of weight; this increases the possible applications of the hydraulic accumulator, for example, in the field of aeronautics and space travel. Furthermore, as a result of the plastic configuration for the outside support ring or parts of it, it can be ensured that the plastic material on the casings will not be damaged on the sharp-edged transition sites. For a metal, individual ring-segment design, also for the indicated buffer ring, high stiff-ness for the container arrangement can moreover be established, so that depending on the application the hydraulic accumulator can be modularly produced according to requirements.

In one preferred embodiment of the hydraulic accumulator according to the invention, it is moreover provided that in addition to the disk valve, on the opposite side on the accumulator a gas valve is used via which the interior of the membrane bladder can be filled. The membrane bladder can also be filled the first time or refilled on site by way of this gas valve.

In another preferred embodiment of the hydraulic accumulator according to the invention, it is moreover provided that the outside contour of the outside support ring in the direction of the gap opening is provided with a convex curvature, and its opposite inside contour, proceeding from the gap opening, is allowed to run in a straight slope which at the site of the entry of the collar part ends in a contact surface which is parallel to the longitudinal axis of the container. This configuration of the outside support ring with a convex curvature on the outside contour and a plane-parallel configuration on the inner contour side leads to especially favorable application of force of the loads of the inner casing into the outside support ring which in this respect is further supported by the outer plastic casing by winding.

Other advantageous configurations of the hydraulic accumulator solution according to the invention are the subject matter of the other dependent claims.

The hydraulic accumulator according to the invention will be detailed below using one embodiment according to the invention. The figures are schematic and not to scale.

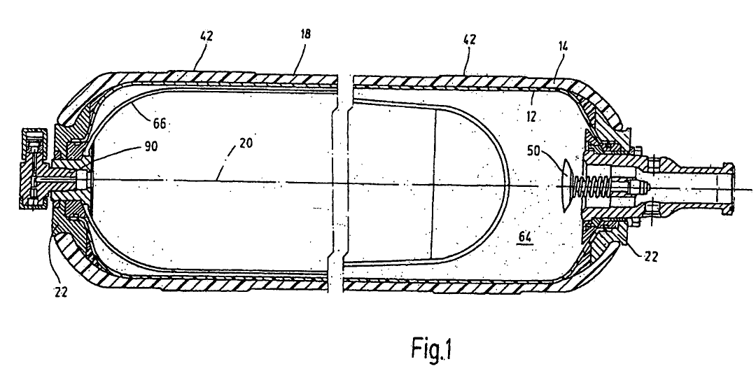

FIG. 1 shows the largest part of a longitudinal section through a hydraulic accumulator made as a bladder accumulator;

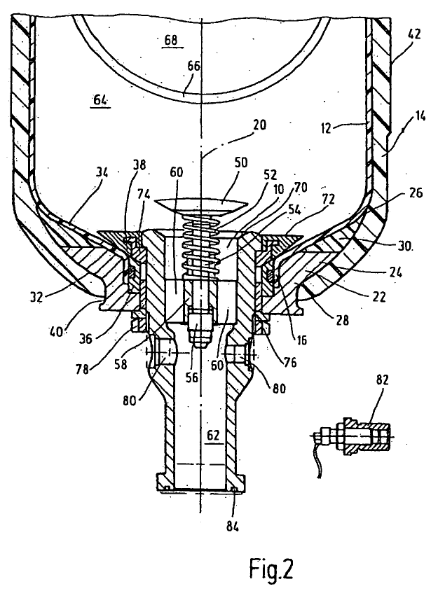

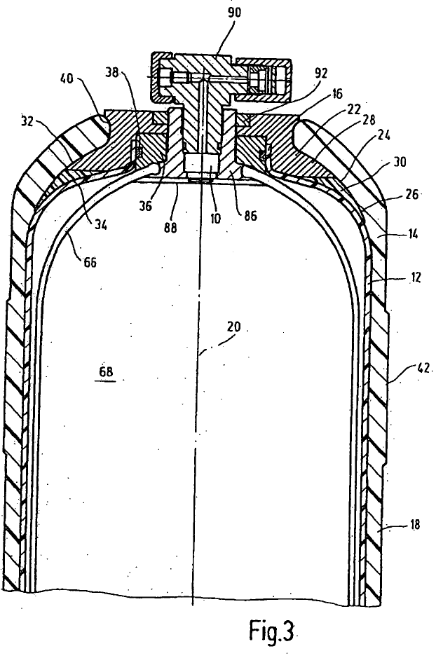

FIGS. 2 and 3 show enlarged the respective end-side region of the hydraulic accumulator as shown in FIG. 1.

The hydraulic accumulator shown in the drawings in the form of a bladder accumulator is used to store liquid or gaseous fluid media which can be under a pressure of up to several thousand bar. It is provided on both ends with connection openings 10 for delivery and discharge of media, to which valves are connected; this will be detailed in particular below.

The actual pressurized container of the hydraulic accumulator has a first plastic casing 12 and a second plastic casing 14 which at least partially surrounds the first plastic casing 12. This first plastic casing 12 is also referred to as a plastic core container or liner in the jargon of the trade. It preferably consists of polyamide and is obtained by means of a blow molding process or by rotary sintering. These production processes are conventional so that they will not be detailed here. The indicated liner 12 is reinforced on the outer peripheral side by a fiber winding which has been wound on from the outside as the second plastic casing 14. For example, the reinforcing winding consists of a fiber reinforcement such as carbon fibers, aramid fibers, gas fibers, boron fibers, Al₂O₃ fibers or of mixtures thereof, which are also referred to as hybrid yarns which are embedded in a basic matrix of duromers, such as epoxy or phenolic resins or in thermoplastics, for example, in the form of PA 12, PA6, PP, etc.

The fiber composite material which forms the support jacket contains fiber strands which are embedded in the plastic resin, which cross one another and which extend essentially in the longitudinal and peripheral direction. The fiber composite material which forms the support jacket can in addition or alternatively also comprise fiber strands which cross one another, which are tilted in the longitudinal and peripheral direction, and in one advantageous development of the longitudinal axis of the plastic core container can be assigned to one another tilted in mirror image. The forces directed longitudinal and peripherally can be optimally accommodated by the pressurized container in this way. Moreover, the possibilities are improved for adjusting the ratio of the opening cross section of one face-side opening with reference to the inside diameter of the plastic core container to large values of at least 30%, preferably of at least 50%, without adversely affecting operation.

On the opposing ends the first plastic casing 12 ends in one respective cylindrical collar part 16. The illustrated hydraulic accumulator is made essentially rotationally symmetrical and extends along its center periphery 18 with a coaxial arrangement of its two casings 12, 14 along its longitudinal axis 20. Viewed in the direction of this longitudinal axis 20, the free end of the second plastic casing 14 ends above the respective collar part 16 of the first plastic casing 12; this has proven favorable for the forces to be delivered during operation of the container. The collar part 16 of the first plastic casing 12 and the second plastic casing 14 are otherwise supported on the outside support ring 22 which lies inside between them. The outside support ring 22 tapers in the direction of the gap opening 24 between the indicated casings 12, 14 in the manner of a wedge. It is provided according to the invention that the indicated gap opening 24 between the casings 12, 14 is routed as far as the location at which the casings 12, 14 in a coaxial arrangement to the longitudinal axis 20 of the accumulator are in contact with one another, the wedge-like taper 26 of the outside support ring 22 leading as far as this site. The outside support ring is either made in one piece, which is not shown, or, as shown in the figure, is composed of at least two annular individual segments 28, 30, the individual segment 28 consisting of a conventional metal material and the individual ring 30 consisting of a plastic material, preferably made in the manner of a buffer ring of a plastically deformable polymer material. Instead of the two individual segments 28, 30 there could also be other individual segments, in the manner of a sandwich construction, or the outside support ring 22 instead of a one-piece metal execution consists of one in plastic.

As furthermore follows from the figures, the outside contour 32 of the outside support ring 22 in the direction of the gap opening 24 is provided with a convex curvature and its opposite inside contour 34 runs, proceeding from the gap opening 24, in a straight slope which ends at the site of the entry of the collar part 16 into a contact surface which is parallel to the longitudinal axis 20 of the hydraulic accumulator. The curvature of the outside contour 32 increases in the direction of the free end of the second plastic casing 14. This inside and outside contour configuration for the outside support ring 22 ensures good application of force and moreover reliable coupling of the indicated plastic casings 12, 14 in the region of the outside support ring 22. Furthermore, the liner in the form of the plastic casing 12 runs parallel to the oblique contour which runs in a straight line on the inside of the outside support ring 22, with the result that the deflection of the liner in the direction of the collar part 16 takes place parallel to the longitudinal axis 20 of the hydraulic accumulator with an angle greater than 90°, so that in this respect sharp deflections for the susceptible liner are avoided.

If the outside support ring 22, as shown, consists of individual segments, at least one of the two individual segments 28 or 30 in the edge-side region can have a projection which ends in the manner of an overlap in an edge-side radial depression of the other individual segment. In this way especially good adhesion of the two individual segments to one another is possible. Viewed in cross section as shown in the figures, therefore one individual segment 30 is made in the manner of a feed edge and the other individual segment 28 as far as the free end of the respective collar part 16 is made in the manner of a parallelogram.

The respective collar part 16 of the first casing 12 is supported on the inner peripheral side on another contact surface of the inside support ring 36 which is preferably made as a rigid metal ring. As the figures show, the inside support ring 36 need not be made the same for the two ends of the hydraulic accumulator; but it is characteristic that the respective inside support ring 36 along its outer peripheral surface has an annular groove for holding the O-ring 38 which is used to seal the respective media delivery and discharge. Furthermore, it is characteristic that the inside support ring 36 is supported in the outside support ring 22 such that a common boundary wall for delivery and discharge of the medium is formed. The illustrated inside support ring 36 in the direction of the interior of the pressurized container is provided with a contact bevel which has a tilt which is matched to the tilt of the bevel of the inside contour 34 of the outside support ring 22 and which in particular corresponds to it. This bevel is used in particular also as a later contact surface for the illustrated valve arrangements of the hydraulic accumulator which are still to be detailed. Furthermore, the outside contour 32 of the outside support ring 22 is provided with a ring-shaped recess 40 in which the assignable end of the second plastic casing 14 ends with contact on the end side.

On both sides of the center periphery 18 the second plastic casing 14 has a least one additional winding layer 42 which on the one hand helps to increase the bursting pressure and on the other ensures that in case of bursting any solid internal parts of the pressurized container or accumulator cannot be shot to the outside, but rather are retained by the additional winding 42. Depending on the overall length of the accumulator, this additional winding 42 may be present only once or repeatedly at discrete distances from one another. The indicated outside support ring 22 is able to uniformly distribute the stress peaks which occur in the manner of a pressure buffer and to deliver them into the two plastic casings 12, 14. In this way, bulging of the pressurized container is effectively avoided. Since in the sense of sliding motion in the coaxial region extremely small delaminating relative movements can occur between the facing sides of the plastic casings 12, 14, it is sufficient here to undertake support and separation of the layers or of the two casings 12, 14 from one another in the end-side enclosure region by the outside support ring 22. The illustrated cross sectional wedge shape of the outside support ring 22 is favorable to the extent it effectively counteracts the indicated relative displacements, to which the different configuration of the outside contour 21 to the inside contour 34 contributes in a supportive manner. In spite of the circumstance that only smooth surfaces are used for the described pressurized container solution, in particular relative to the inside support ring 36 and the outside support ring 22, it is surprising that in this way a high-strength and stiff connecting part in the region of the collar part 16 is achieved in a structurally simple manner.

Viewed in the direction of looking at FIG. 2, on the bottom of the tank arrangement the fluid valve is a so-called disk valve 50. The disk of the disk valve 50 as shown in FIG. 2 is held in its open position by a compression spring 52 and otherwise the disk is borne by an actuating rod 54 which extends through the compression spring 52 and which is designed to limit the maximum opening stroke on its bottom with a stop 56 which as shown in FIG. 2 strikes the bridge walls 58 of a guide which in the axial direction parallel to the longitudinal axis 20 of the hydraulic accumulator exposes diametrically opposite fluid passages. The indicated fluid passages 60 discharge in the direction of looking at FIG. 2 on their lower end into a fluid-carrying fitting 62 in the manner of a standardized SEA flange and on their opposite end they discharge into the fluid space 64 of the indicated hydraulic accumulator. This fluid space 64 is separated from another gas-carrying working space 68 by way of an elastomer separating membrane in the form of a bladder 66. If fluid, for example, in the form of a hydraulic medium such as oil, is retrieved from the fluid space 64 via the fitting 62 into a hydraulic circuit, the elastically yielding bladder 66 expands under the pressure of the working gas, for example, in the form of nitrogen, and viewed in the direction of looking at FIG. 2, presses the disk of the disk valve 50 down until at most in the complete closed position the disk comes into contact with the conical closing surfaces 70 of the indicated SAE flange which projects in this respect into the fluid space 64.

If the indicated SAE fitting projects into the fluid space 64, in an adjacent arrangement to the conical closing surfaces 70 it is encompasses with an elastically yielding stop surface 72 and is held on the indicated flange by a bent collar piece 74. With its bottom this collar piece 74 is supported on the inside contour of the obliquely running liner 12. Furthermore, the collar piece 74 on its inner peripheral side is held on the SAE flange, which flange widens in diameter over a projection on the outer peripheral side. Otherwise this SAE flange is made cylindrical in the passage region, and viewed in the direction of looking at FIG. 2 is supported on the bottom of the outside support ring 22 by way of a support sleeve 76 which on the outer peripheral side is in flat contact with the inner peripheral sides of the outside support ring 22 and the inside support ring 36. In order to reliably attach this arrangement in the region of the media delivery and discharge 10 in the accumulator housing, a screw ring 78 braces the indicated arrangement which can be clamped onto the SAE flange in this respect over the outside threaded segment. Underneath the screw ring 78 which has been fixed in this way, the SAE flange is penetrated by two diametrically opposing holes 80 which can be used, for example, to hold sensors which otherwise can be used to measure pressure, temperature, viscosity and the like. The pressure sensor 82 which is shown at the right viewed in the direction of looking at FIG. 2 as a screw-in part is held integrated into the hole 80 which is shown at left. In order to achieve better installation capacity of the indicated parts, in particular the collar piece 74 can be built as a multi-piece, in particular two-part ring. Furthermore, the SAE flange viewed in the direction of looking at FIG. 2 on its end-side bottom has an annular recess 84 which is used to hold an O-ring which is not detailed, so that in this respect the SAE flange can be connected to the fluid circuit of a hydraulic system which is not detailed, forming a seal.

As FIG. 3 furthermore shows, the membrane wall of the bladder 66 on its top is held in a membrane holding device 86 which with its bottom can be connected into the transverse wall 88 of the bladder arrangement; otherwise, however, in this transverse wall region a passage site 10 is exposed for gas supply via the media supply valve 90 as well. This valve 90 is of conventional design so that it will no longer be detailed here, and the valve 90 can be screwed into the internal thread of the membrane holding device 86 by way of the corresponding outside thread. For reliable holding of the bladder 66 it is somewhat thickened in diameter on its free end and the membrane holding device 86 clamps the free end of the bladder 66 against the inclined contact surface of the inside support ring 36 which is this respect rests with its inside periphery against the outside periphery of the membrane holding device 86. Otherwise the membrane holding device 86 with a slight projection penetrates the fitting 22 and is fixed in position in it via a pressure ring 92. In the illustrated pressurized container the plastic core container has an inside diameter of 240 mm and the connecting ring has an inside diameter of 140 mm. The pole ratio is computed therefrom, i.e., the ratio of the inside diameter of the plastic core container 12 and the inside diameter of the connecting ring or inside support ring 36 of 58%, i.e., a value greater than 50%; this facilitates accommodation of internals in the plastic core container, such as the indicated valve means 50 and 90.

1. A hydraulic accumulator, in particular a bladder accumulator, for holding at least one fluid medium, with a pressurized container with a first plastic casing (12) and a second plastic casing (14) which at least partially encompasses the first plastic casing (12), the first plastic casing (12) at least on its one end having a collar part (16) which comprises an opening (10) for a valve for triggering the delivery and discharge of the medium, and the collar part (16) and the second plastic casing (14) being supported on an interposed outside support ring (22) which tapers in the manner of a wedge in the direction of the gap opening (24) between the indicated casings (12, 14), characterized in that the gap opening (24) between the casings (12, 14) is routed as far as the site at which the casings (12, 14) are in contact with one another in a coaxial arrangement, and that for triggering the delivery and discharge of the medium in the opening (10) the valve is a disk valve (50).

2. The hydraulic accumulator according to claim 1, wherein the outside support ring (22) is made in one piece or is composed of at least two annular individual segments (28, 30).

3. The hydraulic accumulator according to claim 2, wherein at least one individual segment (30) consists of a plastic material.

4. The hydraulic accumulator according to claim 1, wherein in addition to the disk valve (50) on the opposite side on the accumulator a gas valve (90) is used via which the interior (68) of the bladder (66) can be filled.

5. The hydraulic accumulator according to claim 1, wherein the outside contour (32) of the outside support ring (22) in the direction of the gap opening (24) is provided with a convex curvature and its opposite inside contour (34), proceeding from the gap opening (24), runs in a straight slope which at the site of the entry of the collar part (16) ends in a contact surface which is parallel to the longitudinal axis (20) of the container.

6. The hydraulic accumulator according to claim 1, wherein the collar part (16) of the first casing (12) is supported on the inner peripheral side on another contact surface of the inside support ring (36) which is likewise made as a rigid metal ring.

7. The hydraulic accumulator according to claim 6, wherein the inside support ring (36) is guided in the outside support ring (22) such that a common boundary wall for the delivery and discharge of the medium is formed.

8. The hydraulic accumulator according to claim 6, wherein the inside support ring (36) in the direction of the interior of the pressurized container is provided with a contact bevel which has a tilt which is matched to the tilt of the bevel of the inside contour (34) of the outside support ring (22).

9. The hydraulic accumulator according to claim 1, wherein the outside contour (32) of the outside support ring (22) is provided with a ring-shaped recess (46) in which the assignable end of the second plastic casing (14) ends with contact.

10. The hydraulic accumulator according to claim 1, wherein the first plastic casing (12) is a plastic liner which is produced by a blow molding or rotary or other thermal process.

11. The hydraulic accumulator according to claim 1, wherein the second plastic casing (14) consists of a winding of at least one type of fibers, which winding forms a fiber reinforcement for the first plastic casing (12) at the site of the respective enclosure.

12. The hydraulic accumulator according to claim 1, wherein the second plastic casing (14) along its outer periphery has an additional winding (42) at discrete distances from one another.
